(19) United States
(12) Patent Application Publication
(10) Pub. No.: US 2003/0167223 A1
(43) Pub. Date: Sep. 4, 2003

(54) System with methodology for improved transmission of financial information

(75) Inventors: Richard Pledereder, Pleasanton, CA (US); Debra Smith, Waterloo (CA); Lyall Chun, San Jose, CA (US)

Correspondence Address: JOHN A. SMART, SYBASE, INC., ONE SYBASE DRIVE, DUBLIN, CA, 94568, US

(73) Assignee: Financial Fusion, Inc., a wholly-owned subsidiary of Sybase, Inc.

(21) Appl. No.: 10/147,394

(22) Filed: May 15, 2002

Related U.S. Application Data
(60) Provisional application No. 60/361,624, filed on Mar. 1, 2002.

(51) Int. Cl. G06F 17/60

(52) U.S. Cl. 705/37

(57) ABSTRACT

A system providing methods for transmission of messages conforming to a financial protocol, such as the Financial Information Exchange (FIX) protocol, which requires a particular message sequencing is described. When one or more messages are received for transmission over a communication channel which does not itself provide support for such message sequencing (e.g., SWIFTNet), an identifier is assigned to each message. This identifier is based upon a particular session and a message sequence number within this session. The message is then transmitted over the communication channel. Upon receipt, the message is placed in sequence to provide the particular message sequencing required by the financial protocol. Proper sequencing is based upon the identifier assigned to each message. The same methodology may be used for transmission of multiple messages from a plurality of sessions over one or more communication channels. Methods for splitting messages between multiple communication channels are also described.

### RELATED APPLICATIONS

The present application is related to and claims the benefit of priority of the following commonly-owned provisional application(s): application serial No. 60/361,624 (Docket No. SYB/0085.00), filed Mar. 1, 2002, entitled “System with Methodology for Improved Transmission of Financial Information”, of which the present application is a non-provisional application thereof. The disclosure of the foregoing application is hereby incorporated by reference in its entirety, including any appendices or attachments thereof, for all purposes.

### COMPUTER PROGRAM LISTING APPENDIX

A Computer Program Listing Appendix, containing eight (8) total files on compact disc, is included with this application.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

1. Field of the Invention

The present invention relates generally to data processing environments and, more particularly, to a system providing methods for improved transmission of financial information.

2. Description of the Background Art

The FIX (Financial Information Exchange) protocol is a peer-to-peer protocol that consists of a specified series of messages for communications between two trading partners (i.e., two counter parties). The FIX protocol (hereinafter “FIX”) is a standard messaging protocol that is typically used to communicate financial information electronically between financial institutions, such as banks and broker/dealers. The FIX messaging protocol is established and maintained by users, typically financial organizations such as broker/dealers, banks, and large institutional investors. For further description of FIX, see e.g., Financial Information Exchange Protocol, version 4.3 (August, 2001), the disclosure of which is hereby incorporated by reference. A copy of the FIX protocol standard is currently available from FIX Protocol Limited at www.fixprotocol.org.

FIX has been rapidly adopted over the last five to seven years and is widely used by financial organizations to conduct transactions electronically. A large broker/dealer may use FIX to exchange information and conduct a number of different types of transactions with a regional broker/dealer. For instance, FIX may be used to accept new order requests for a certain number of shares of a specified security. FIX may also be used by a selling broker/dealer to advertise availability of a security to a series of trading partners. If one of these trading partners is interested in purchasing the available security, FIX may also be used to initiate and execute a trade of such securities.

FIX is a peer-to-peer protocol that connects two parties (often referred to as “counter parties”). FIX includes a set of application-level messages, including more than 20 different types of messages that define particular types of communications and transactions. FIX also includes approximately seven session-level message types that define connectivity between parties. FIX defines a session-level protocol, or series of messages, which are used for establishing a session between two counter parties. FIX also defines an application-level protocol, or series of messages, for exchanging payload. A FIX session is typically operated on top of the TCP/IP protocol using network socket connections. Each counter party generally operates its own FIX Engine (which implements the FIX session-level and application-level protocols).

The FIX session-level protocol facilitates connecting instances of two different FIX engines maintained by two counter parties. This permits these counter parties to talk to each other in a meaningful fashion using FIX. In order to make sure that a FIX session can survive communication failures as well as hardware and software outages on either end of the session, while at the same time detecting whether there is a message gap or duplicate messages sent, these session-level messages implement a reliable store-and-forward protocol between the counter parties. This store and forward protocol provides for persistent storage on both ends and guaranteed delivery. In this context, guaranteed delivery means that the sender is ensured that a message is delivered at least once and the recipient is ensured that each message is processed exactly once.

FIX engines are available from a number of suppliers. Representative suppliers include Financial Fusion, Inc. (a Sybase company), Javelin Technologies of New York, N.Y., and Cameron Systems of New York, N.Y. In some cases, these FIX engines are part of a larger system, such as an order management system. In addition, a number of financial institutions have developed and implemented their own FIX engines for communication with other financial institutions and organizations. Two FIX engines typically connect to each other over TCP/IP and use the session-level protocol to establish a FIX session between the two counter parties, enabling the exchange of application-level messages. FIX does not require use of TCP/IP or any other particular communication mechanism, however effectively all existing FIX engines currently use TCP/IP for FIX communications. These FIX communications are typically transmitted over a Virtual Private Network (VPN), leased lines and/or the Internet, and are protected by encryption using SSL (Secure Sockets Layer), PGP (Pretty Good Privacy), or the like.

SWIFT (Society for Worldwide Interbank Financial Telecommunication) has for a number of years offered a network primarily to assist hundreds of banks and financial institutions worldwide with electronic transfers of funds and other back-office operations. SWIFT supports approximately 200 messages (or more) over an X.25-based private network. Recently, SWIFT commenced modifying its existing X.25-based infrastructure with SIPN (Secure IP Network) technology to create a private network called SWIFTNet. SWIFTNet is comparable to a virtual private network in providing secure communications between parties, but with the addition of a number of value-added facilities, including security features such as non-repudiation. SWIFTNet is used for a large number of financial transactions, including both back-office and front-office applications. Back-office applications of SWIFTNet include settlement of funds and electronic transfers for which the X.25-based SWIFT network has historically been used. Front-office applications include securities marketing and trading applications, such as handling initiation and execution of stock trades. Because SWIFTNet is a secure virtual private network for communications between parties, SWIFTNet may also be used for front-office applications (e.g., securities trading) in addition to its traditional role in handling back-office applications (e.g., funds settlement).

One downside of FIX is that it is a point-to-point (or peer-to-peer) protocol, meaning that connectivity must be individually established with each trading partner. This means that a financial institution using the FIX protocol must establish and maintain connectivity with multiple trading partners. Establishing and maintaining connectivity includes ensuring that one is using protocols compatible with that of each trading partner (e.g., a compatible version of FIX). For example, if a first financial institution has 100 trading partners, it must establish, validate, and maintain 100 connections. In addition, this financial institution may have to establish and maintain these connections using different protocols (i.e., versions of FIX) with various counter parties. For instance, 55 of these 100 trading partners may use version 4.1 of the FIX protocol, another 35 may use version 4.2, and the remaining 10 may use other versions. Establishing and maintaining connections with a large number of trading partners becomes very complex and expensive for this reason, among others.

Another problem with establishing and maintaining connections with each trading partner is that it is inconvenient to establish a different security policy for each FIX connection to a different organization. Establishing and maintaining these connections may require provisioning of a number of different access points, which may require multiple communication lines using different security methods (e.g., VPN, SSL, and PGP security). Current FIX technology also does not easily allow the effective use of multiple communication channels for transmission of FIX messages. FIX messages are frequently sent over a single channel because of the sequencing requirements of the FIX protocol, among other reasons. As the number of firms having FIX engines and participating in these types of transactions increases, the complexity of maintaining this type of peer-to-peer network increases dramatically.

Because of these costs and complexities of maintaining a peer-to-peer network, as well as other reasons, there are today several hub and spoke solutions on the market that may be used for FIX transactions between participating parties. Among the advantages of using a hub and spoke solution for FIX transactions is that each participant must only validate their FIX engine against the hub, and need not validate proper connectivity with each trading partner. However, none of these existing hub and spoke solutions utilize SWIFTNet for communications between participants. In addition, none of these existing solutions are in widespread use and, thus, a participant typically must continue with peer-to-peer communications with parties not utilizing one of these solutions. As SWIFTNet is already in widespread use by financial institutions and provides for secure communications between these institutions, there is considerable interest in a solution that will enable FIX transactions to be conducted over SWIFTNet. Preferably, this solution should enable FIX transactions to be conducted over multiple channels, including SWIFTNet, and should work with existing FIX engines, thereby avoiding the cost and expense of modifying existing FIX engines to work with SWIFTNet or support multiple communication channels. The present invention fulfills these and other needs.

### GLOSSARY

The following definitions are offered for purposes of illustration, not limitation, in order to assist with understanding the discussion that follows.

base-64 encoding: base-64 encoding is a widely used approach for encoding binary data (e.g., within mail messages) before transporting the data through a communication network that allows relatively short lines of 7-bit data units. The encoding algorithm processes a byte stream in 3-byte sequences. Each 3-byte sequence parcels into four 6-bit data units. Further description of base-64 encoding is available in RFC 2045, the disclosure of which is hereby incorporated by reference. A copy of RFC 2045 is currently available at http://www.ietf.org.

FIX: FIX stands for Financial Information eXchange Protocol, an open message standard for exchange of financial information. The FIX effort was initiated in 1992 by a group of institutions and brokers interested in streamlining their trading processes through the electronic communication of indications, orders and executions. The FIX messaging protocol is a message standard that is widely used by financial organizations and is not controlled by any single entity. For further description of FIX, see e.g., Financial Information Exchange Protocol, version 4.3 (August, 2001), the disclosure of which is hereby incorporated by reference. A copy of the FIX protocol standard is currently available from FIX Protocol Limited at www.fixprotocol.org.

HTTP: HTTP is the acronym for HyperText Transfer Protocol, which is the underlying communication protocol used by the World Wide Web on the Internet. HTTP defines how messages are formatted and transmitted, and what actions Web servers and browsers should take in response to various commands. For example, when a user enters a URL in his or her browser, this actually sends an HTTP command to the Web server directing it to fetch and transmit the requested Web page. Further description of HTTP is available in “RFC 2616: Hypertext Transfer Protocol—HTTP/1.1,” the disclosure of which is hereby incorporated by reference. RFC 2616 is available from the W3C, and is currently available via the Internet at http://www.w3.org/Protocols/. Additional description of HTTP is available in the technical and trade literature, see e.g., Stallings, W. “The Backbone of the Web,” BYTE, October 1996, the disclosure of which is hereby incorporated by reference.

HTTPS: HTTPS stands for Hypertext Transfer Protocol over Secure Socket Layer, or HTTP over SSL, a communications protocol designed to transfer encrypted information between computers over the World Wide Web. HTTPS involves the use of a Secure Socket Layer (SSL) as a sublayer under HTTP.

SSL: SSL is an abbreviation for Secure Sockets Layer, a protocol developed by Netscape for transmitting private documents over the Internet. SSL works by using a public key to encrypt data that is transferred over the SSL connection. Both Netscape Navigator and Microsoft Internet Explorer support SSL, and many Web sites use the protocol to obtain confidential user information, such as credit card numbers. SSL creates a secure connection between a client and a server, over which data can be sent securely. For further information, see e.g., The SSL Protocol, version 3.0, (Nov. 18, 1996) from the Internet Engineering Task Force (IETF), the disclosure of which is hereby incorporated by reference.

SWIFT: SWIFT (Society for Worldwide Interbank Financial Telecommunication) is a cooperative society organized under Belgian law and owned by members of the financial industry. SWIFT supplies secure messaging services and interface software to over 7,000 financial institutions in over 150 countries. Further information regarding SWIFT is currently available on the Internet at www.swift.com.

SWIFTNet: SWIFTnet is an IP-based messaging network operated by SWIFT which enables the secure communication of financial information and transactional data. SWIFTNet is a private network operated by SWIFT, an industry owned cooperative.

TCP: TCP stands for Transmission Control Protocol. TCP is one of the main protocols in TCP/IP networks. Whereas the IP protocol deals only with packets, TCP enables two hosts to establish a connection and exchange streams of data. TCP guarantees delivery of data and also guarantees that packets will be delivered in the same order in which they were sent. For an introduction to TCP, see e.g., RFC 793, the disclosure of which is hereby incorporated by reference. A copy of RFC 793 is currently available at http://www.ietf.org.

TCP/IP: TCP/IP stands for Transmission Control Protocol/Internet Protocol, the suite of communications protocols used to connect hosts on the Internet. TCP/IP uses several protocols, the two main ones being TCP and IP. TCP/IP is built into the UNIX operating system and is used by the Internet, making it the de facto standard for transmitting data over networks. For an introduction to TCP/IP, see e.g., “RFC 1180: A TCP/IP Tutorial,” the disclosure of which is hereby incorporated by reference. A copy of RFC 1180 is currently available at ftp://ftp.isi.edu/in-notes/rfc1180.txt.

X.25: X.25 is a packet switched data network protocol which defines an international recommendation for the exchange of data as well as control information between a user device (host) and a network node. In 1976 X.25 was recommended as the common network interface protocol for connection of networks by the International Consultative Committee for Telegraphy and Telephony (CCITT), which has since been renamed the International Telecommunication Union (ITU). It is currently one of the most widely used interfaces for data communication networks. For further description of X.25, see e.g., ITU-TX:25, Interface between Data Terminal Equipment (DTE) and Data Circuit-terminating equipment (DCE) for terminals operating in the packet mode and connected to public data networks by dedicated circuit (October, 1996) and Recommendation X.25 Corrigendum 1 (September, 1998), the disclosure of which is hereby incorporated by reference. A copy of the ITU-T X:25 recommendation is currently available from the ITU at www.itu.int as Article Number E 9971.

XML: XML stands for Extensible Markup Language, a specification developed by the W3C. XML is a pared-down version of SGML, designed especially for Web documents. It allows designers to create their own customized tags, enabling the definition, transmission, validation, and interpretation of data between applications and between organizations. For further description of XML, see e.g., “Extensible Markup Language (XML) 1.0,” (2nd Edition, Oct. 6, 2000) a recommended specification from the W3C, the disclosure of which is hereby incorporated by reference. A copy of this specification is currently available on the Internet at http://www.w3.org/TR/2000/REC-xml-20001006.

### SUMMARY OF THE INVENTION

The present invention comprises a system providing methods for transmission of messages conforming to a financial protocol, such as the Financial Information Exchange (FIX) protocol, which specifies a particular message sequencing over a communication channel which does not itself provide support for such message sequencing (e.g., SWIFTNet). When one or more messages are received for transmission, an identifier is assigned to each message. This identifier is based upon a particular session and a message sequence number within this session. In the currently preferred embodiment, the message is also converted to a format appropriate for transmission over the communication channel. The message is then transmitted over the communication channel to the destination. Upon receipt of each message at its destination, the message is placed in sequence to provide the particular message sequencing required by the financial protocol. Proper sequencing is based upon the identifier assigned to each message. Although the above refers to the transmission of a single message, the present invention may also be used for transmission of multiple messages from multiple sessions over one or more communication channels. The present invention also provides methods for splitting message traffic between multiple communication channels, as desired.

### BRIEF DESCRIPTION OF THE DRAWINGS

FIG. 1 is a block diagram of a computer system in which software-implemented processes of the present invention may be embodied.

FIG. 2 is a block diagram of a software system for controlling the operation of the computer system.

FIG. 3 illustrates an exemplary environment in which the present invention may be utilized for establishing a communication channel over the SWIFT network for transmission of FIX messages.

FIG. 4 is a block diagram of the currently preferred embodiment of an environment in which the FIX to SNL bridge system of the present invention may be embodied.

FIG. 5 illustrates the components of the main bridge of the FIX to SNL bridge of the present invention.

FIGS. 6A-B comprise a single flowchart illustrating the detailed method steps associated with establishing a session for two parties to exchange FIX messages over SWIFTNet.

FIG. 7 illustrates the detailed method steps of operation of the present invention in the exchanging of FIX messages over SWIFTNet.

### DETAILED DESCRIPTION OF A PREFERRED EMBODIMENT

The following description will focus on the presently preferred embodiment of the present invention, which is implemented in general purpose computer system, such as a server computer running under an operating system, such as the Microsoft® Windows XP operating system. This computer system may be connected to one or more public or private networks, including the Internet. The present invention, however, is not limited to any one particular application or any particular environment. Instead, those skilled in the art will find that the system and methods of the present invention may be advantageously embodied on a variety of different platforms, including Macintosh, Linux, BeOS, Solaris, UNIX, NextStep, FreeBSD, and the like. Therefore, the description of the exemplary embodiments that follows is for purposes of illustration and not limitation.

I. Computer-Based Implementation

A. Basic System Hardware (e.g., for Desktop and Server Computers)

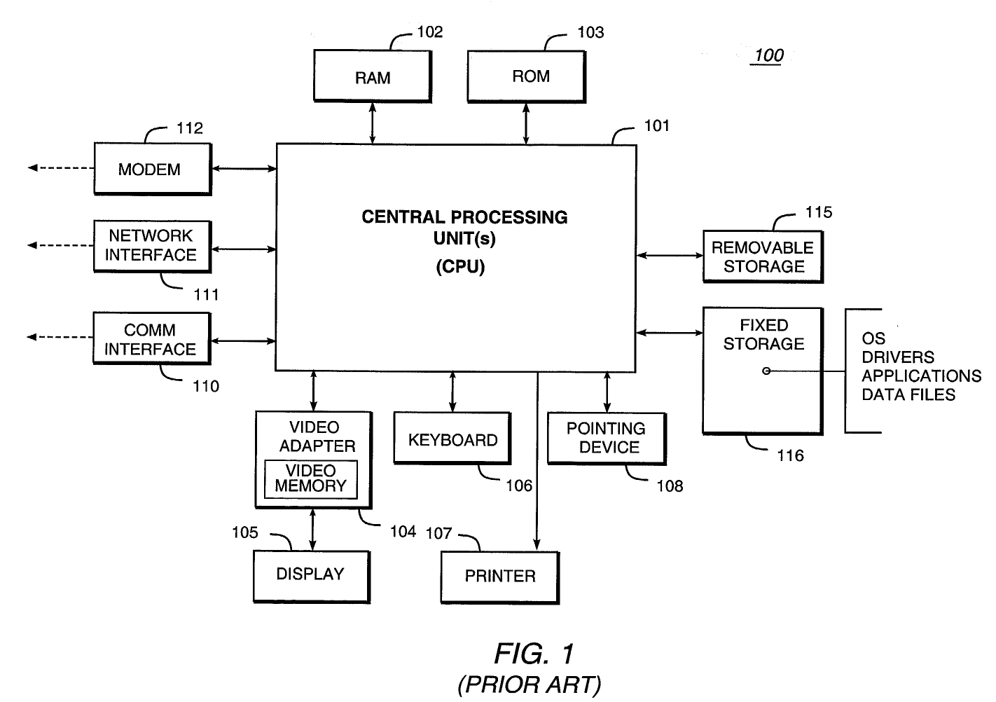

The present invention may be implemented on a conventional or general-purpose computer system, such as an IBM-compatible personal computer (PC) or server computer. FIG. 1 is a very general block diagram of an IBM-compatible system 100. As shown, system 100 comprises a central processing unit(s) (CPU) or processor(s) 101 coupled to a random-access memory (RAM) 102, a read-only memory (ROM) 103, a keyboard 106, a printer 107, a pointing device 108, a display or video adapter 104 connected to a display device 105, a removable (mass) storage device 115 (e.g., floppy disk, CD-ROM, CD-R, CD-RW, DVD, or the like), a fixed (mass) storage device 116 (e.g., hard disk), a communication (COMM) port(s) or interface(s) 110, a modem 112, and a network interface card (NIC) or controller 111 (e.g., Ethernet). Although not shown separately, a real-time system clock is included with the system 100, in a conventional manner.

CPU 101 comprises a processor of the Intel Pentium® family of microprocessors. However, any other suitable processor may be utilized for implementing the present invention. The CPU 101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 102 serves as the working memory for the CPU 101. In a typical configuration, RAM of sixty-four megabytes or more is employed. More or less memory may be used without departing from the scope of the present invention. The read-only memory (ROM) 103 contains the basic input/output system code (BIOS)—a set of low-level routines in the ROM that application programs and the operating systems can use to interact with the hardware, including reading characters from the keyboard, outputting characters to printers, and so forth.

Mass storage devices 115, 116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 1, fixed storage 116 stores a body of program and data for directing operation of the computer system, including an operating system, user application programs, driver and other support files, as well as other data files of all sorts. Typically, the fixed storage 116 serves as the main hard disk for the system.

In basic operation, program logic (including that which implements methodology of the present invention described below) is loaded from the removable storage 115 or fixed storage 116 into the main (RAM) memory 102, for execution by the CPU 101. During operation of the program logic, the system 100 accepts user input from a keyboard 106 and pointing device 108, as well as speech-based input from a voice recognition system (not shown). The keyboard 106 permits selection of application programs, entry of keyboard-based input or data, and selection and manipulation of individual data objects displayed on the screen or display device 105. Likewise, the pointing device 108, such as a mouse, track ball, pen device, or the like, permits selection and manipulation of objects on the display device. In this manner, these input devices support manual user input for any process running on the system.

The computer system 100 displays text and/or graphic images and other data on the display device 105. The video adapter 104, which is interposed between the display 105 and the system's bus, drives the display device 105. The video adapter 104, which includes video memory accessible to the CPU 101, provides circuitry that converts pixel data stored in the video memory to a raster signal suitable for use by a cathode ray tube (CRT) raster or liquid crystal display (LCD) monitor. A hard copy of the displayed information, or other information within the system 100, may be obtained from the printer 107, or other output device. Printer 107 may include, for instance, an HP LaserJet® printer (available from Hewlett-Packard of Palo Alto, Calif.), for creating hard copy images of output of the system.

The system itself communicates with other devices (e.g., other computers) via the network interface card (NIC) 111 connected to a network (e.g., Ethernet network, Bluetooth wireless network, or the like), and/or modem 112 (e.g., 56K baud, ISDN, DSL, or cable modem), examples of which are available from 3Com of Santa Clara, Calif. The system 100 may also communicate with local occasionally-connected devices (e.g., serial cable-linked devices) via the communication (COMM) interface 110, which may include a RS-232 serial port, a Universal Serial Bus (USB) interface, or the like. Devices that will be commonly connected locally to the interface 110 include laptop computers, handheld organizers, digital cameras, and the like.

IBM-compatible personal computers and server computers are available from a variety of vendors. Representative vendors include Dell Computers of Round Rock, Tex., Compaq Computers of Houston, Tex., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

B. Basic System Software

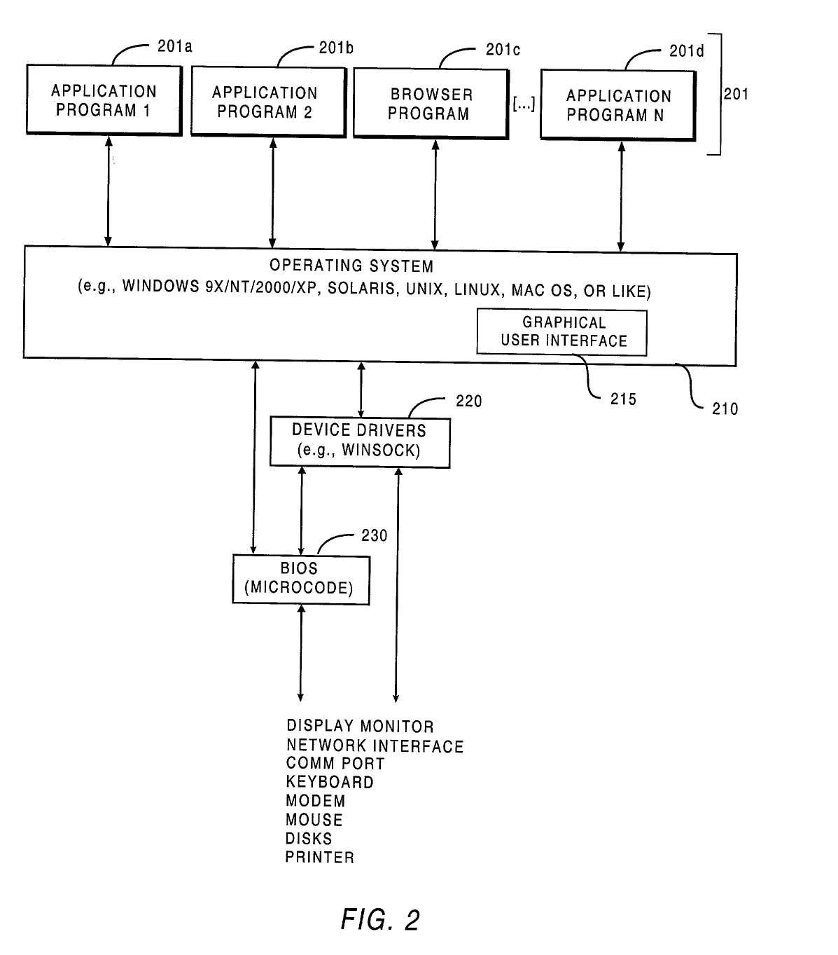

Illustrated in FIG. 2, a computer software system 200 is provided for directing the operation of the computer system 100. Software system 200, which is stored in system memory (RAM) 102 and on fixed storage (e.g., hard disk) 116, includes a kernel or operating system (OS) 210. The OS 210 manages low-level aspects of computer operation, including managing execution of processes, memory allocation, file input and output (I/O), and device I/O. One or more application programs, such as client application software or “programs” 201 (e.g., 201a, 201b, 201c, 201d) may be “loaded” (i.e., transferred from fixed storage 116 into memory 102) for execution by the system 100.

Software system 200 includes a graphical user interface (GUI) 215, for receiving user commands and data in a graphical (e.g., “point-and-click”) fashion. These inputs, in turn, may be acted upon by the system 100 in accordance with instructions from operating system 210, and/or client application module(s) 201. The GUI 215 also serves to display the results of operation from the OS 210 and application(s) 201, whereupon the user may supply additional inputs or terminate the session. Typically, the OS 210 operates in conjunction with device drivers 220 (e.g., “Winsock” driver—Windows' implementation of a TCP/IP stack) and the system BIOS microcode 230 (i.e., ROM-based microcode), particularly when interfacing with peripheral devices. OS 210 can be provided by a conventional operating system, such as Microsoft® Windows 9x, Microsoft® Windows NT, Microsoft® Windows 2000, or Microsoft® Windows XP, all available from Microsoft Corporation of Redmond, Wash. Alternatively, OS 210 can also be an alternative operating system, such as the previously-mentioned operating systems.

The above-described computer hardware and software are presented for purposes of illustrating the basic underlying desktop and server computer components that may be employed for implementing the present invention. The following discussion references the use of the present invention for communications between two server computers. The present invention, however, is not limited to any particular environment or device configuration. In particular, a configuration involving two computer servers is not necessary to the invention, but is used to provide a framework for discussion. Instead, the present invention may be implemented in any type of system architecture or processing environment capable of supporting the methodologies of the present invention presented in detail below.

II. System Providing Improved Methods for Exchange of Financial Information

A. Transparent Operation of FIX Engines Over SWIFTNet

The FIX (Financial Information Exchange) protocol specifies a series of messages for connecting two trading partners, i.e., two counter parties. Today, each counter party typically operates one or more FIX engine(s) (i.e., servers or engines which implement the FIX protocol), with these FIX engines connecting to each other over TCP/IP using network socket connections. The present invention includes a system providing methods enabling FIX engines that ordinarily communicate over TCP/IP to communicate over SWIFTNet without requiring any modifications to the FIX engines. The present invention also supports transmission of messages conforming to a financial protocol (e.g., FIX messages) over multiple communication channels (e.g., SWIFTNet and HTTPS). A system constructed in accordance with the present invention provides a bridge enabling arbitrary FIX engines that today communicate with each other over TCP/IP to communicate with each other over multiple channels, including SWIFTNet and HTTPS.

In particular, the present invention enables the transparent operation of TCP/IP-based FIX engines over SWIFT's SWIFTNet. The present invention bridges TCP/IP-based FIX traffic to SWIFTNet by acting as a gateway for bridging this TCP/IP-based traffic to SWIFTNet both on an originating end (i.e., traffic sent by an initiating FIX engine) as well as on a receiving end (i.e., by a target FIX engine). It operates at both the originating and receiving connection points implementing communication layering in which the bottom communication layer is SWIFT Net, the middle layer is a TCP/IP layer on top of SWIFTNet, and the top layer is FIX over TCP/IP. In effect, a first instance of the bridge takes the TCP/IP FIX traffic (i.e., messages conforming to FIX protocol) and modifies this traffic so that it may be transmitted over SWIFTNet (a communication channel) at one end (the initiating end). Another instance of the bridge at the other end (the receiving end) receives and reconverts SWIFT traffic to recreate a TCP/IP FIX stream, and provides this FIX stream to the target FIX engine. As a result, the present invention enables existing FIX engines to communicate over SWIFTNet instead of directly communicating with each other over TCP/IP on a point-to-point basis. In addition, the system and methodology of the present invention does not require modification of existing FIX engines in order to communicate over SWIFTNet in this fashion. The system may be configured to use only SWIFTNet for communication. However, the system may also be configured to transmit and receive FIX protocol messages over multiple communications channels, including SWIFTNet and HTTPS. If multiple communication channels are used, the present invention enables traffic to be split amongst such channels for transmission. This traffic is recombined after receipt (at the destination) for proper delivery to the destination FIX engine.

Although the above discussion refers to “an originating end” and “a receiving end,” a user of the present invention may utilize a single instance of the system of the present invention for communication with a plurality of parties via multiple communication channels, including SWIFTNet and HTTPS. The system acts as a bridge or gateway between each user's FIX engine and the SWIFT network. At the side of the gateway facing a local user's FIX engine, the system typically uses a TCP/IP communication mechanism which appears to the local FIX engine as if the local FIX engine was communicating with a counter party using the FIX protocol. In the currently preferred embodiment, a TCP/IP listener accepts requests (e.g., socket creation requests) from the local FIX engine, manages socket connections that are created, and processes traffic from the local FIX engine over these socket connections. A FIX engine may open many connections to multiple counter parties using the system of the present invention. The system manages these connections and ensures the communication is routed to the appropriate counter party as hereinafter described.

The other side of the system (i.e., the same local instance of the bridge or gateway system of the present invention) communicates with the SWIFT network (referred to herein as either “SWIFTNet” or “the SWIFT network”). The system of the present invention uses the local SWIFTNet libraries for communication with SWIFTNet. As communications (e.g., messages) are received from the local FIX engine, the system (referred to herein as the “FIX to SNL bridge”) examines the content of each particular message and identifies the counter party that is to receive the message. The FIX to SNL bridge also converts FIX messages that are received from the local FIX engine into a format appropriate for transmission via SWIFTNet. In addition, the system provides for proper sequencing of messages. The FIX protocol generally requires that FIX messages be delivered to a counter party in the same sequence as they are sent. However, SWIFTNet currently does not guarantee this sequencing of messages. Accordingly, the present system also maintains the sequencing of FIX messages which are transmitted over SWIFTNet and/or other communication channels. The system also maps FIX-based addressing to SWIFT-based addressing, providing for delivery of messages to the appropriate party over SWIFTNet.

B. System Architecture and Basic Operation

1. Basic System Components

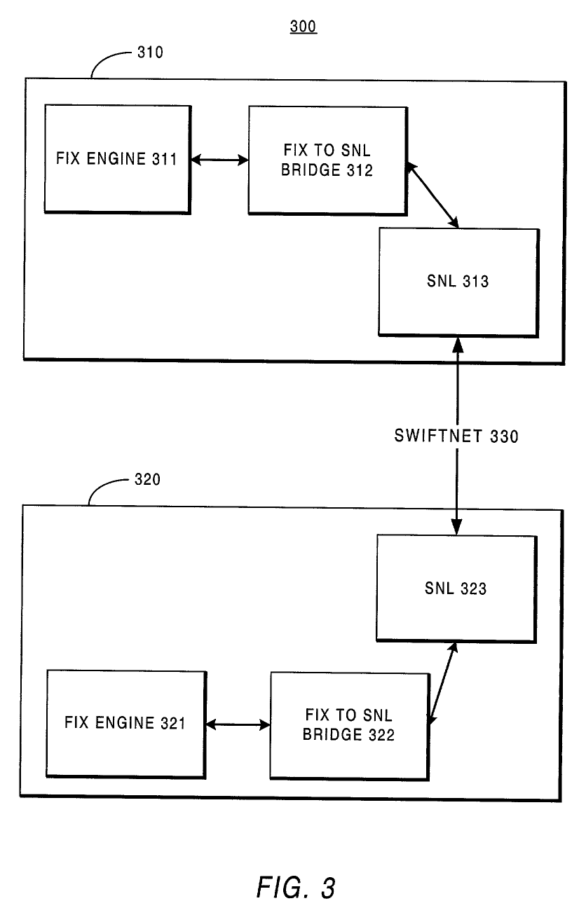

FIG. 3 illustrates an exemplary environment 300 in which the present invention may be utilized for establishing a communication channel over the SWIFT network and transmitting FIX messages over this communication channel. The present invention is typically implemented in an environment including at least two machines, although a different number of machines may be utilized. For purposes of illustrating the methodology of the present invention, the exemplary environment 300 includes two machines, which are designated as machine 310 and machine 320, respectively. Machines 310 and 320 are shown connected via SWIFT network (SWIFTNet) 330. In this exemplary embodiment, one FIX engine is installed on each of these two machines (FIX engine 311 on machine 310 and FIX engine 321 on machine 320). FIX engines (e.g., FIX engines 311, 321) are available from a number of suppliers or may be user developed. Representative vendors of FIX engines include Financial Fusion, Inc. (a Sybase company), Javelin Technologies of New York, N.Y., and Cameron Systems of New York, N.Y. No modifications to these existing FIX engines are required for implementation of the present invention.

The FIX to SNL bridge system of the present invention is also installed on each machine (e.g., on machines 310 and 320) in this exemplary implementation. FIX to SNL bridge 312 interacts with FIX engine 311 on machine 310 to bridge FIX communications which are either initiated by (or targeted to) FIX engine 311 and are transmitted (or to be transmitted) or received over SWIFTNet 330. FIX to SNL bridge 322 serves in a similar role for FIX engine 321 on machine 320. In effect, FIX to SNL bridges 312 and 322 serve as gateways providing connectivity between FIX engines 311 and 321 via the SWIFTNet 330.

Finally, both machines include SWIFTNet Link (SNL) components (SNL 313 on machine 310 and SNL 323 on machine 320). SWIFTNet Link (SNL) 313, 323 are two instances of an existing component for placing messages onto, and receiving messages from, the SWIFT network (e.g., SWIFTNet 330). This component, which is currently available from SWIFT as SWIFTNet Link version 4.1, is implemented as a daemon or process which typically runs on a client machine (e.g., machines 310 and 320) and serves as a communication interface to the SWIFTNet 330. The sequence of operations of these components will now be described.

2. Component Start-Up Sequence

The SWIFTNet Link (SNL) component (e.g., SNL processes 313, 323) is usually the first process started on each machine on which the present invention is implemented (e.g., machines 310 and 320 as shown at FIG. 3). The FIX to SNL bridge (e.g., bridges 312 and 322) on a machine is typically started following initiation of the SNL process and registers itself with the SNL process, which is on the same machine in this exemplary implementation. Each FIX engine (e.g., FIX engines 311, 321 and any associated database servers) is typically started after the local FIX to SNL bridge registers with the SNL process.

The following example assumes, for purposes of illustrating the operations of the system of the present invention, that only one FIX session is opened between machine 310 and 320 via SWIFTNet 330. However, the system and methodology of the present invention may also be used for establishment of multiple FIX sessions from one or more machines. When configuring a given FIX engine, the FIX engine will be configured to point to the FIX to SNL Bridge, which resides on the same machine in this exemplary implementation. For example, a FIX engine may be configured to communicate to a FIX to SNL bridge at a particular IP address and port. The FIX to SNL bridge is configured to listen on this same port.

3. Connection Sequence

In response to a user command, such as from a graphical user interface (GUI), FIX engine 311 on machine 310 may request initiation of a connection to FIX engine 321 on machine 320. In response, a TCP/IP socket connection is opened from FIX engine 311 to FIX to SNL bridge 312 on machine 310. Continuing with its connection process, FIX engine 311 will automatically generate a log-on message and send this log-on message via the session's socket. As the socket connection has already been established between FIX engine 311 and FIX to SNL bridge 312, bridge 312 receives the FIX log-on message. FIX to SNL bridge 312 packages this FIX message into a format acceptable for transmission over SWIFTNet and pushes the newly formatted message to the SNL process 313, which is installed on machine 310 in this exemplary implementation. The SNL process may then submit the message to the SWIFT network (SWIFTNet) 330.

When this connection message is received by the SWIFTNet Link (SNL) 323 process on machine 320, SNL 323 calls the registered callback process of FIX to SNL bridge 322, pushing the message to FIX to SNL bridge 322. The bridge 322 extracts the FIX message from the message received from SNL 323. In other words, FIX to SNL bridge 322 reformats the message into FIX format. The FIX to SNL bridge 322 then creates a socket connection to FIX engine 321 and pushes the FIX message (i.e., the connection message) to FIX engine 321 through this socket connection.

There are some differences in how socket connections are established by a FIX to SNL bridge to its local FIX engines. For example, a FIX to SNL bridge communication with an FIX engine which initiates the session connection (i.e., outbound communication from FIX engine 311 in the above example) is somewhat different than that used for communication with the same FIX engine for inbound communication (i.e., when the FIX engine 321 accepts a socket connection from FIX to SNL bridge 322). The following illustrates how connectivity is established between the FIX engines and the SWIFT network via the FIX to SNL bridges:

SOCKET gfixSocket = null;
main( )
{

Initialization( ); /* includes registration with SNL */
/*
* For the initiator side only.
*/
// Listen for socket connection requests on port XXX.
listen (PORT);
// Accept the socket request.
gfixSocket = accept( );
/* End of initiator side only */
/*
* For the acceptor side only.
*/
while (gfixSocket == null) {

/*
* Loop until we get a socket connection.
* The socket will be connected by the SNL callback.
*/

}
/* End of acceptor side only */
/* For both sides */
while ( true ) {

read entire FIX message from gfixSocket
package into SNL format
submit to SNL

}

} /* end of main( ) */
The callback procedure registered with SNL is:
callback( SNL message)
{

/*
* For the acceptor side only.
*/
if (gfixSocket == null)

create socket connection to GFIX

/* End of acceptor side only */
extract FIX message from SNL message;
write FIX message to gfixSocket

} /* end callback( ) */

After the above steps, subsequent FIX messages may flow from FIX engine 311 to FIX engine 321 as hereinafter described.

4. Subsequent Message Flow

After connectivity has been established, FIX messages from FIX engine 311 will flow from component to component of the above systems as follows:

FIX engine 311 ==> Bridge 312 ==> SNL 313 ==> SWIFT Network 330 ==> SNL 323 ==> Bridge 322 ==> FIX engine 321

The message flow of a given FIX message is very similar to the connection sequence described above. FIX engine 311 sends a FIX message via the session's socket. As the socket connection has already been established between FIX engine 311 and FIX to SNL bridge 312, the bridge receives the FIX message. The FIX to SNL bridge 312 converts the message by packaging the FIX message into a format acceptable for transmission over SWIFTNet 330 and pushes the newly formatted message to SNL 313.

This SNL process (SNL 313) transmits this newly formatted message over the SWIFT network 330. When the message is received by SNL 323 on machine 320, SNL 323 calls FIX to SNL bridge 322's registered callback process, pushing the message up to bridge 322. The FIX to SNL bridge 322 extracts the FIX message from the received message (i.e., reconverts the message to FIX format) and then pushes the FIX message to FIX engine 321 through the previously-established socket connection. FIX message flow from FIX engine 321 to FIX engine 311 is simply the reverse of the above. The components of the FIX to SNL bridge of the present invention will now be described.

C. Block Diagram of an Instance of FIX to SNL Bridge System

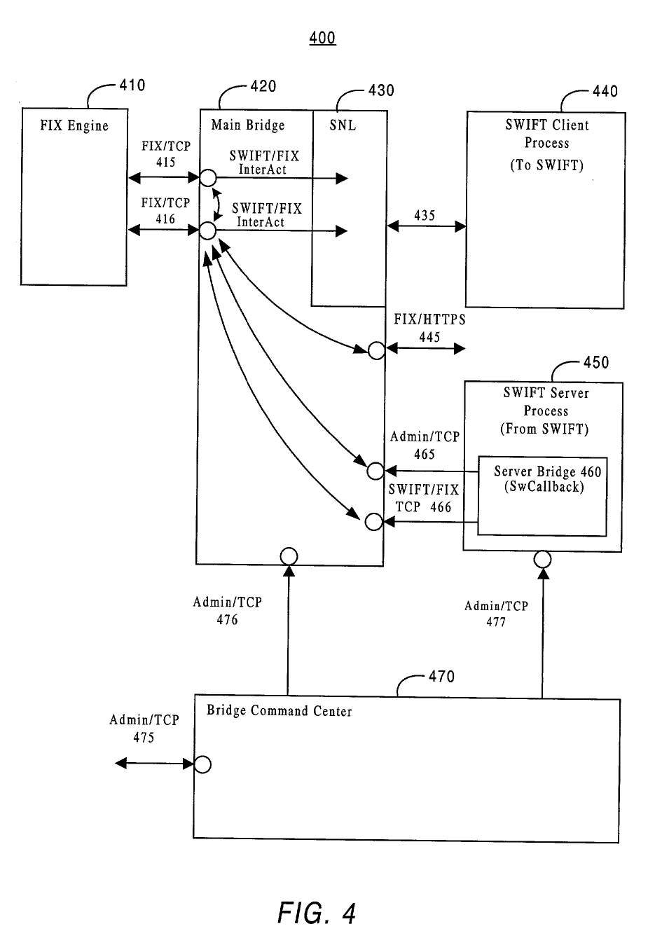

As described above, the FIX to SNL bridge provides a gateway or link between the TCP/IP channel (which is the standard communication channel currently used for FIX message transmission) and other communication channels, including SWIFTNet and HTTPS. Although the currently preferred embodiment utilizes SWIFTNet and HTTPS communication channels, those skilled in the art will appreciate that the present invention may also be used in conjunction with other communication channels. FIG. 4 is a block diagram of the currently preferred embodiment of an environment 400 in which the FIX to SNL bridge system of the present invention may be embodied. Recall from FIG. 3, that a typical environment in which the present invention may be implemented generally includes at least two FIX to SNL bridges (e.g., FIX to SNL bridges 312, 322) serving as gateways for two or more parties with FIX engines (e.g., FIX engines 311, 321) connected to SWIFTNet 330 (e.g., via SNL processes 313, 323). FIG. 4 illustrates an environment 400 illustrating the components of a single FIX to SNL bridge system (i.e., a single instance of the system) of the present invention.

As shown, environment 400 includes a FIX engine 410 sending a FIX message via TCP/IP channels 415, 416 to a main bridge 420, a SWIFTNet Link (SNL) component or process 430 interacting with the main bridge 420, a SWIFT client process 440 connected via SWIFT channel 435 to SNL process 430, a FIX/HTTPS channel 445, a SWIFT server process 450, a server bridge 460 receiving communications from SWIFT server process 450 and communicating with main bridge 420 via Admin/TCP channel 465 and SWIFT/FIX TCP channel 466, and a bridge command center 470 connected to main bridge 420 and server bridge 460 via Admin/TCP channels 476, 477. The bridge command center 470 also has an Admin/TCP channel 475 for communication with other components (e.g., a user interface).

The FIX to SNL bridge system of the present invention, in its currently preferred embodiment, comprises the main bridge 420, the server bridge 460, and the bridge command center 470, all as shown at FIG. 4. The main bridge 420 communicates with the local FIX engine(s) and is the core of the system. The main bridge 420 handles the TCP channels 415, 416 to one or more FIX engine(s) (e.g., FIX engine 410 as shown at FIG. 4). A single instance of the main bridge 420 can support multiple FIX sessions. Alternatively, a cluster of FIX to SNL bridges may be utilized to support a plurality of FIX engines for load balancing, for fail-over protection, or for other reasons. The main bridge 420 listens for incoming TCP/IP connections from FIX engines, handles splitting of traffic between SWIFTNet and HTTPS, and converts messages into a format appropriate for transmission. For instance, the main bridge 420 typically encodes the messages for transmission over SWIFTNet. In the currently preferred embodiment, base-64 encoding is used as base-64 encoding allows binary and non-binary data to be transferred as ASCII data.

The main bridge 420 also sends messages over SWIFTNet via interaction with SNL process 430, and sends and receives messages over HTTPS via FIX/HTTPS channel 445. SNL process 430 is a local SWIFT library, typically installed on the same machine as the main bridge 420, that the main bridge links to in order to interface with SWIFTNet. The main bridge 420 can take a single FIX session from a local FIX engine (e.g., FIX engine 410), split the traffic based upon message type for transmission over SWIFTNet or HTTPS protocol (i.e., HTTP over SSL), and then send the message in the appropriate format. For instance, the main bridge may split the traffic by sending lower value messages, such as indications of interest, over HTTPS to reduce costs or for other reasons. As shown at FIG. 4, the main bridge 420 handles all HTTPS traffic as well as outbound SWIFTNet traffic.

The server bridge 460 receives FIX messages from a SWIFT (SWIFTNet) server process 450 and forwards these messages to the main bridge 420. Currently, a single process may not have both client (sender) and server (listener) connections open to the SWIFT network. For this reason, the server bridge 460 is a separate component from the main bridge 420 that is responsible for accepting messages from SWIFT server process 450 and sending these messages to the main bridge 420 via SWIFT/FIX TCP channel 466. The server bridge 460 is invoked by SWIFTNet (e.g., using SwCallback, a registered callback function) and relays incoming SWIFTNet traffic to the main bridge 420.

When messages are received (e.g., from server bridge 460 or FIX/HTTPS channel 445), the main bridge 420 makes sure that all message queues are properly managed, re-converts the messages as required, and passes these messages to FIX engine 410 via TCP channels 415, 416. This may include queuing and sequencing of FIX messages to ensure delivery in sequenced order as hereinafter described. As part of this process the main bridge receiving messages may also collect and possibly reassemble (i.e., re-sequence) traffic that may have been split between two or more communication channels (e.g., split between SWIFTNet and HTTPS by the main bridge sending the messages as illustrated at FIG. 4).

A third component of the FIX to SNL bridge system is bridge command center 470, which accepts commands (e.g., administrative commands from a user via Admin/TCP channel 475) to monitor the main bridge 420 and server bridge 460. The bridge command center 470 issues instructions (e.g., commands to launch) to the main bridge 420 and the server bridge 460 via Admin/TCP channels 476, 477. The bridge command center 470 may also be used to determine the operational status of components of the FIX to SNL bridge system and to stop (i.e., shut down) the system. The components and operations of the main bridge 420, the server bridge 460, and the bridge command center 470 will now be described in greater detail.

D. Components and Operations of Main Bridge

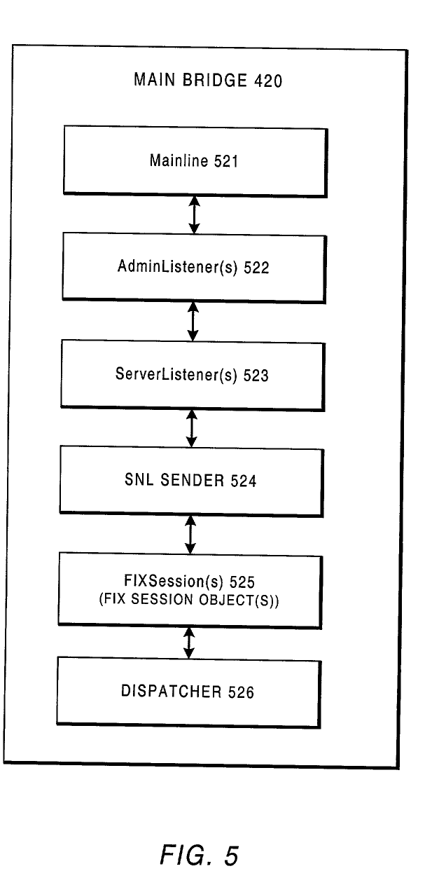

FIG. 5 illustrates the components of the main bridge 420 of the FIX to SNL bridge of the present invention. As shown, the components of the main bridge 420 include a mainline 521 which listens for incoming socket connections and other requests, one or more AdminListener(s) 522 which listen for incoming administrative messages from server bridge 460 or bridge command center 470), one or more ServerListener(s) 523 which listen for incoming messages from the server bridge 460, a SNL sender 524 which handles sending of messages over SWIFTNet via SNL process 430, one or more FIXSession(s) 525 which handles messages to be sent or received over a FIX session, and a dispatcher 526 which holds references to other components and establishes connections as required. Each of these components of main bridge 420 and their operations will now be described.

The mainline component 521 represents the main thread of execution for the main bridge 420. The mainline 521 is responsible for initialization and cleanup of the dispatcher 526, SNL sender 524, and TCP listener sockets. Once the main bridge 420 is accepting connections, the mainline 521 is responsible for accepting connection requests on the TCP listener sockets and invoking the dispatcher 526 to create instances of the appropriate AdminListener(s) 522, ServerListener(s) 523 or FIXSession(s) 525 to handle the new connection. The mainline component 521 is also responsible for processing requests from the console, including quit requests.

The AdminListener(s) 522 represent connected administrative channel(s). Each instance of this AdminListener component runs on its own thread and reads administrative requests from the connection. As administrative messages are received, they are passed by AdminListener(s) 522 to the dispatcher 526 for processing. In the currently preferred embodiment, there are two instances of the AdminListener component 522 in existence at a time: one from the server bridge 460, and one from the bridge command center 470.

The ServerListener(s) 523 represent open connection(s) with the server bridge 460. In the currently preferred embodiment, there is one instance of this ServerListener 523 component in the main bridge 420 containing a thread that receives messages from the server bridge 460. Messages received from the server bridge 460 typically comprise a base64-encoded representation of a FIX message, plus the SNL identifier of the remote SNL main bridge that sent this FIX message. The ServerListener 523 converts the received message into a FIX message object that contains the raw FIX message and a session identifier for this FIX message. The FIX message object contains the information described below:

class FIXMessage {

| // sequence number from the FIX message | |
|---|---|
| int | _sequence; |
| // session identifier of the sending session consisting of | |
| // SenderCompID:SenderSubId | |
| char | * _senderId; |
| // session identifier of the target session consisting of | |
| // TargetCompID:TargetSubId | |
| char | * _targetId; |
| // unique session identifier composed of | |
| // SenderCompID:SenderSubId-TargetCompID:TargetSubID | |
| char | * _sessionId; |
| // FIX message type | |
| char | * _msgType; |
| // indicates whether message is a possible duplicate in | |
| // accordance with the FIX protocol | |
| bool | _possDup; |
| // indicates whether this message causes a sequence number | |
| // reset | |
| bool | _resetSequence; |
| // indicates whether a gap fill of messages is requested | |
| bool | _gapFill; |
| // specified the new sequence number for a message that | |
| // causes a sequence number reset | |
| int | _newSequence; |
| // raw FIX message | |
| char | * _message; |
| // the length of the raw FIX message | |
| int | _messageLen; |
| // indicates the maximum buffer size for storing a FIX message | |
| int | _messageCapacity; |

}

As illustrated above, in the currently preferred embodiment, the session identifier (char * _sessionId) is created by concatenating the Sender and Target Comp and Sub IDs (SendercompID:SenderSubId-TargetCompID:TargetSubID) in order to uniquely identify the FIX session to which a given FIX message belongs. The FIX message object (including the SNL identifier) is then passed to the dispatcher 526 for routing to the appropriate FIXSession 525.

The SNL sender 524 is responsible for sending messages to the SWIFT network via SNL process 430. In the currently preferred embodiment, there is one instance of SNL sender 524 in the main bridge 420. The SNL sender 524 includes a thread that is responsible for taking messages that are to be sent from an outgoing message queue, and sending these messages to the SNL process 430 for transmission over SWIFTNet (e.g., via channel 435 to SWIFT client process 440 as shown at FIG. 4). Each message on the outgoing message queue handled by the SNL sender 524 typically includes the following information:

class SNLSender {

// queue of messages to be sent, contains SNLQueueItems
ArrayQueue sendQueue;
// contains handles to asynch SNL messages
ArrayQueue handleQueue;

}
class SNLQueueItem {

// payload of the message
char * _message;
// FIX session identifier
char * _fixSessionId;
// SNL identifier of the receiving end
char * _responder;
// handle from the asynch send
char * _rqRef;
// number of times to retry sending
int _retryCount;
// indicates whether the message is prepared in a buffer
// ready for sending
bool _msgPrepared;

}

As shown above, each message on the outgoing message queue typically includes payload data, an identifier for the FIX session (char * _fixSessionId) from which this message originated (if applicable), the identifier of the SNL destination (char * _responder), and a retry counter. Messages are removed from the outgoing message queue and bundled in the payload of an SNL message. SNL messages are sent asynchronously over SWIFTNet, and a handle to the message is stored by the SNL sender 524 on a list of pending messages. Each item on the pending message list is checked via a call to SNL process 430 to ensure that the message was delivered. Messages that have been successfully delivered have their handles removed from the handle list. If the initial transmission fails, or if the message is sent over SWIFTNet but is undeliverable, then the message is either re-queued on the message queue after incrementing the retry counter, or it is discarded and the corresponding FIXSession 525 is closed. The queue processing code serves to ensure that the number of outstanding handles will not exceed a pre-selected limit.

Each FIXSession object 525 represents a session connection to a FIX server (e.g., FIX engine 410 as shown at FIG. 4). Typically, one instance of FIXSession object 525 exists for each connected FIX session and holds an open TCP socket connection to a FIX engine. A FIXSession object 525 generally holds the following information:

class FIXSession {

| // the session id of the sending FIX session | |
|---|---|
| char | * _sessionId; |
| // the session id of the receiving FIX session | |
| char | * _remoteSessionId; |
| // the SNL address of the receiver | |
| char | * _sn1Responder; |
| // the TCP connection to the FIX server | |
| Socket | * _fixSocket; |
| // the next sequence number to send | |
| int | _senderSequence; |

// an ordered queue of FIX messages to be sent, ordered
// by FIX sequence number
PriorityQueue * _senderQueue;

}

As shown above, a FIXSession object typically contains the session ID of the sending FIX session, the TCP socket connection to the FIX engine, the sequence number of the next message to be sent to the FIX server (engine) for this session, an ordered queue of the FIX messages (FIXMessage) which are to be sent, and the SNL identifier of the SNL server bridge (e.g., server bridge 460 as shown at FIG. 4) which is to receive the FIX messages sent from this session. In the currently preferred embodiment, the queue of FIX messages is ordered by the sequence number of each FIX message. There are generally two threads associated with each instance of FIXSession object 525: a receiving thread, and a sending thread. Each of these threads will be briefly described.

The receiving thread is responsible for receiving messages from a FIX engine (e.g., from FIX engine 410 via FIX/TCP connections 415, 416 as shown at FIG. 4). As FIX messages are received, they are encoded via base64, bundled into a payload for delivery over SWIFTNet, and queued for the SNL sender 524 for delivery to the destination SNL server bridge, which is usually identified by an SNL identifier received from the FIX engine sending the message.

The sending thread is responsible for delivering messages to the FIXSession(s) in sequenced order. The FIX protocol requires that messages be delivered in order of sequence number. Messages arriving over SWIFTNet may be received out of order, so it is necessary for the FIXSession(s) 525 to reorder messages as they arrive. This reordering is generally accomplished by inserting FIX messages into an ordered delivery queue, and by keeping track of the sequence number of the next message to deliver to the FIX engine 410. The sending thread ensures that messages are delivered in order, with two usual exceptions: FIX messages which are marked as possible duplicates or whose sequence numbers are lower than expected are usually delivered upon receipt; and FIX messages which are not marked as possible duplicates and whose sequence number is lower than expected are typically discarded. During the processing of FIX messages, the sending thread also looks for FIX messages which cause the sequence number to be reset to a new value, and changes the next expected sequence number accordingly.

If FIX messages are queued for delivery and the sending thread is unable to deliver any FIX messages for a given interval, then the FIX message on the queue with the highest sequence number is delivered and all other messages from the queue are discarded. This causes the (local) FIX engine to ask the remote FIX engine to resend any messages that have not yet been received. In the event that the TCP connection is closed, a FIXSession object 525 will typically queue itself for shut down by the dispatcher 526.

The dispatcher 526 acts as a central manager for the main bridge system, handling the creation and removal of AdminListener(s) 522, ServerListener(s) 523, and FIXSession(s) 525. The dispatcher 526 holds references to the AdminListener(s) 522, ServerListener(s) 523, and FIXSession(s) 525. It is responsible for establishing session connections (FIXSession(s) 525) as required, routing FIX messages from SWIFTNet (via the server bridge 460 and ServerListener 523 components) to the appropriate FIXSession 525, and cleaning up the resources of anything to which it holds a reference. To facilitate removal of these objects, the dispatcher 526 uses a thread to process queued requests to remove these objects. In the currently preferred embodiment, there is one dispatcher 526 in the main bridge 420. As FIX messages are received by the ServerListener(s) 523, they are passed to the dispatcher 526 for routing to the appropriate FIXSession(s) 525 for delivery. The dispatcher 526 keeps a hash table of FIXSession(s) 525, generally keyed by their session identifiers as shown below:

class Dispatcher {

// hash table of FIXSession objects, used to map sockets to
// session ids to SNL addresses
StringMap _sessionMap;
// queue of shutdown requests
ArrayQueue _shutdownReqQueue;

}

When a FIX message is received from a ServerListener 523, the session identifier of the FIX message is used to find the corresponding FIXSession 525 in the hash table. If no FIXSession 525 is found for the specified session identifier, then the dispatcher creates a new FIXSession 525 and attempts to create a new TCP connection to the FIX server (e.g., FIX engine 410). If the connection is established, then the new FIXSession object 525 is added to the hash table. Once a new FIXSession 525 is created, the FIX message is queued for delivery in this FIXSession.

When the FIX engine 410 initiates a TCP connection to the main bridge 420, the dispatcher 526 is invoked to create a new FIXSession 525 for this TCP connection. The dispatcher 526 reads the first FIX message from this connection to construct the session identifier before passing the FIX message to the new FIXSession object 525 to be bundled and sent over SWIFTNet. When sessions are created, the SNL identifier of the remote SNL server bridge that is to receive any messages from this session is also set. For sessions whose TCP connections are initiated by the FIX engine 410, the SNL identifier is typically retrieved from a configuration file. For sessions whose TCP connections are initiated by an SNL main bridge, the SNL identifier is generally the SNL identifier of the SNL main bridge sending the FIX message over SWIFTNet.

The dispatcher 526 also processes administrative requests from the AdminListener(s) 522. Administrative requests can include a request to shut down the main bridge 420, or a request to shut down a particular FIXSession 525. The latter request may be received from a remote SNL main bridge that has lost its connection to the applicable FIX engine for the corresponding FIXSession.

The dispatcher 526 also includes a shutdown thread for processing requests to shut down AdminListener(s) 522, ServerListener(s) 523, and FIXSession(s) 525. The shutdown thread is usually a separate thread to facilitate thread cleanup when the request is generated by the instance that is to be shut down. When FIXSession(s) are shut down, an administrative message may be sent via the SNLSender 524 to the remote SNL main bridge to request that the corresponding FIX session be shut down. This may occur the session is being shut down because the TCP connection to the FIX engine was closed by the FIX engine.

E. Operations of Server Bridge

As previously illustrated at FIG. 4, the role of server bridge 460 is to receive FIX messages from SWIFTNet via SWIFT server process 450 and forward them to the main bridge 420. The SWIFT server process 450 (which listens for incoming messages) is currently implemented by SWIFT as a Tuxedo service. In order to properly interface with the architecture of the SWIFT network, the currently preferred embodiment of the server bridge 460 is implemented as a callback (SwCallback) controlled by the SWIFTNet server process 450.

Upon starting, the server bridge 460 starts up a thread that listens on Admin/TCP channel 477 for administrative commands from the bridge command center 470. For example, the bridge command center 470 may send a ‘shut down’ message to instruct the server bridge 460 to shut itself down. In the event a shut down message is received, the server bridge 460 finishes any pending activities, closes all sockets, and shuts down.

The server bridge 460 also receives messages from SWIFTNet via SWIFT server process 450. Messages that may be received include both FIX messages as well as administrative messages from a remote FIX to SNL bridge. When a message is received, the server bridge 460 opens TCP sockets to the main bridge 420. In the currently preferred embodiment, the server bridge 460 opens Admin/TCP channel 465 and SWIFT/FIX TCP channel 466 to the main bridge 420. SWIFT/FIX TCP channel 466 is used to send FIX messages received from the SWIFT server process 450 to the main bridge. FIX messages that are received by the server bridge typically comprise a base64-encoded FIX message included within an XML wrapper or envelope. The server bridge extracts the FIX message data from the XML envelope and sends this data, together with the SNL address of the sender via the open SWIFT/FIX TCP channel 466 to the main bridge 420. The Admin/TCP channel 465 is used to send administrative commands received by the server bridge from SWIFTNet (i.e., from SWIFT server process 450) to the main bridge.

F. Administration by Bridge Command Center

The bridge command center 470 accepts commands to monitor the main bridge 420 and the server bridge 460 and also launches these other components when required (e.g., in response to a command received via Admin/TCP channel 475). The bridge command center 470 listens on Admin/TCP channel 475 for incoming administrative commands and communicates with the main bridge 420 via Admin/TCP channel 476 and with the server bridge 460 via Admin/TCP channel 477, as shown at FIG. 4. The command messages are typically received as XML-format messages. The commands supported by bridge command center 470 include the following:

Start SNL server bridge. This command causes the server bridge to be launched.

Start SNL main bridge. This command causes the main bridge to be launched.

Stop SNL server bridge. When this command is received (e.g., over Admin/TCP channel 475), the bridge command center 470 sends a command to via Admin/TCP channel 477 to server bridge 460 instructing the server bridge to shut down.

Stop SNL main bridge. When this command is received (e.g., over Admin/TCP channel 475), the bridge command center 470 sends a command to via Admin/TCP channel 476 to the main bridge 420 instructing the main bridge to shut down.

Is SNL server bridge alive. This command asks the bridge command center 470 to determine if the server bridge 460 is operational.

Is SNL main bridge alive. This command asks the bridge command center to determine if the main bridge is running.

As described above, the bridge command center serves an administrative role in coordinating the actions of the components of the FIX to SNL bridge system of the present invention. The operations of the system in establishing one or more communication channels for delivery of FIX messages will now be described.

G. Session Establishment and Message Delivery

The following discussion describes how two exemplary FIX engines (e.g., a “buy side” FIX engine and a sell side” FIX engine) may establish a FIX session and exchange FIX messages with each other over SWIFTNet. Referring back to FIG. 3, the buy side FIX engine may be FIX engine 311 on machine 310 and the sell side engine may be FIX engine 321 on machine 320 connected to each other via the SWIFT network 330.

1. Establishing a Communication Channel to SWIFTNet

SWIFTnet users (or counter parties) wishing to use the FIX to SNL bridge system of the present invention for exchange of FIX messages via SWIFTnet, start by launching the FIX to SNL bridge and establishing a communication channel to SWIFTNet. To establish a communication channel to SWIFTNet, both the buy side and sell side counter parties launch their respective FIX to SNL bridges to communicate with SWIFTNet and prepare for the initiation of a FIX session by performing the following steps:

1. Start the main bridge. The main bridge is started and commences listening for incoming TCP connection(s) from a FIX engine.

2. Start the server bridge. The server bridge is launched and makes a TCP connection to the local main bridge.

3. Start the FIX engine(s). The FIX engine is started and establishes a TCP connection to the main bridge, which typically resides locally on the same machine or at the same site.

After both the buy side and the sell side counter parties have successfully performed the above steps, they both have a communication channel open to SWIFTNet. To enable the exchange of FIX messages, they will next proceed to establish a FIX session as described below.

2. Establishing a FIX Session

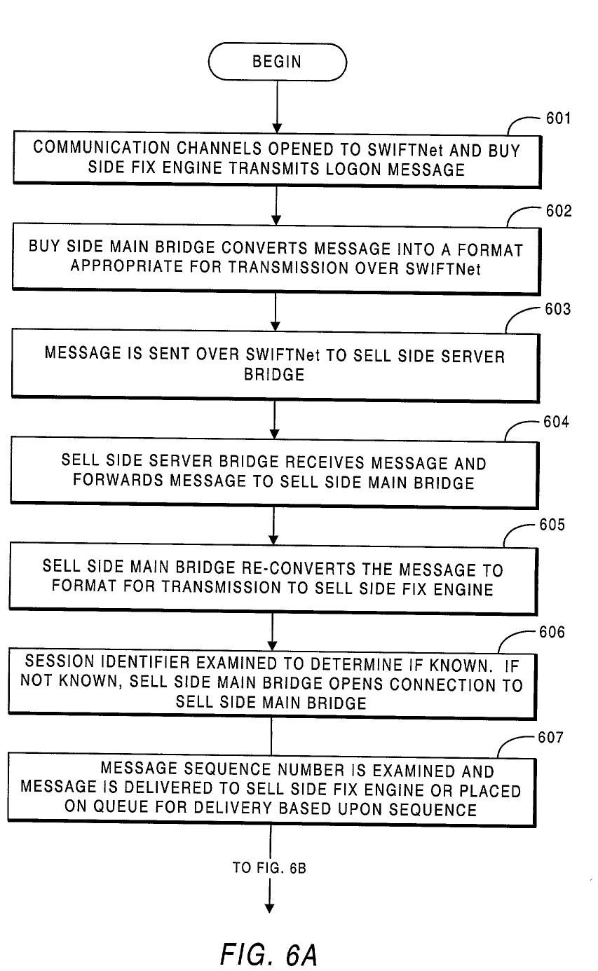

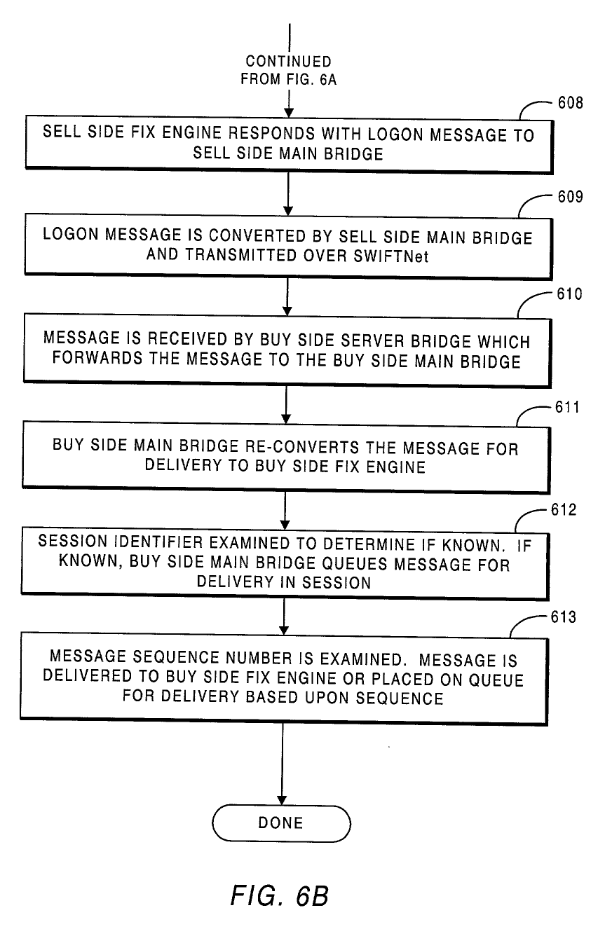

After both parties (i.e., the buy side and the sell side FIX engines) have opened a communication channel to SWIFTNet, they can proceed to establish a session for exchange of FIX messages. FIGS. 6A-B comprise a single flowchart illustrating the detailed method steps associated with establishing a session for two parties to exchange FIX messages over SWIFTNet. To illustrate the methodology of the present invention, the following discussion uses the example of the establishment of a single FIX session for exchange of FIX messages between two parties (or counter parties) referred to as the buy side party and the sell side party. However, the present invention is not limited to use in this context and it may also be used for establishing multiple FIX sessions between multiple parties. In addition, the present invention may also be used for exchange of FIX messages over HTTPS as an alternative to, or in addition to, the exchange of FIX messages over SWIFTNet.

As shown at FIGS. 6A-B, the method commences, at step 601, with the transmission by the FIX engine of the buy side party of a logon message to the buy side main bridge. As previously described, the FIX engine typically uses the previously established FIX/TCP channels for communication with the main bridge. The buy side main bridge may be on the same machine as the FIX engine or, alternatively, may be installed on a separate machine. Upon receipt of the logon message, at step 602 the buy side main bridge converts the message to a format appropriate for transmission via SWIFTNet. In the currently preferred embodiment, the message is base64-encoded, bundled in a SWIFTNet wrapper (or envelope), and queued for delivery to SWIFTNet. The SNL address of the sell side server bridge is included in, or attached to, the message.

At this point, the logon message is ready to be sent from the buy side main bridge to the sell side server bridge via SWIFTNet. At step 603, the buy side main bridge removes the message from the queue and sends it over SWIFTNet to the sell side server bridge using the SNL address of the sell side server bridge. The SNLSender component of the buy side main bridge generally interacts with the (buy side) SWIFTNet Link component to transmit messages over SWIFTNet. At step 604, the sell side server bridge receives the logon message (e.g., from a SWIFT server process as previously described) and passes the logon message to the sell side main bridge. The logon message is passed from the sell side server bridge to the sell side main bridge via the open connection between the two. As described above, TCP connections are opened between the main bridge and the server bridge on both the buy side and sell side as part of the process of establishing a communication channel to SWIFTNet.

When the logon message is received by the sell side main bridge, at step 605 the sell side main bridge re-converts the message for supply to the sell side FIX engine. In general, re-converting the message largely involves the reverse of the process used on the buy side to convert the message for transmission over SWIFTNet. The logon message is extracted from the SWIFTNet envelope. The message is then decoded and session information is attached to the decoded message. The decoded message with the attached session information is then passed to the dispatcher component of the sell side main bridge. The dispatcher examines the session identifier of the message to determine whether the FIX session is known on the sell side main bridge (e.g., by determining if session information is included in a hash table of FIX session information maintained by the sell side main bridge). Typically, a logon message is not yet known by the sell side main bridge, and the main bridge recognizes that it does not yet have a channel (e.g., TCP connection) open to the sell side FIX engine.

At step 606, the sell side main bridge opens a connection to the sell side FIX server. The session identifier information for this session is added to the hash table of FIX sessions maintained by the sell side main bridge and the message is queued for delivery in this FIX session. At step 607, the sequence number of the FIX message is examined. If the message is the next message expected, then the message is delivered to the sell side FIX engine. Any queued messages that are next in the sequence are also delivered. However, if the message is not the next message expected (meaning it is out of order), then the message is placed in the queue and the main bridge waits for delivery of the expected message.

When the logon message is received by the sell side FIX engine, at step 608 the sell side FIX engine responds with a logon message to the sell side main bridge over the TCP connection between the two. When the sell side main bridge receives the logon message from the sell side FIX engine, at step 609 this logon message is converted and transmitted over SWIFTNet to the destination (i.e., buy side) server bridge. The same process is used on the sell side as previously used on the buy side. In the currently preferred embodiment, this includes base64-encoding the message, bundling it in a SWIFTNet wrapper or envelope, attaching the destination address (e.g., the address of the buy side server bridge), and sending it over SWIFTNet to the buy side server bridge.

When the message is received by the buy side server bridge, at step 610 the buy side server bridge passes the message to the buy side main bridge. Next, at step 611 the buy side main bridge re-converts the message in the same manner previously used on the sell side. The buy side main bridge extracts the message, decodes it, and attaches session information to the (re-converted) message.

Next, at step 612 the session identifier of the message is examined to determine whether the FIX session is known to the buy side main bridge (e.g., by comparing the session identifier to known values retained in a hash table of FIX session information). Typically, the FIX session is known as it was initially supplied by the buy side main bridge. If this is the case, the buy side main bridge queues the message for delivery in the FIX session. The main bridge also, at step 613, handles delivery of the message to the buy side FIX engine. This main bridge first examines the sequence number of the FIX message. If the message is the next message expected, then the message is delivered to the buy side FIX engine and any queued messages that are next in the sequence are also delivered. However, if the message is not the next message expected (meaning it is out of order), then the message is queued for delivery. In this situation, the message is delivered following delivery of the expected message as previously described. The delivery of the message to the buy side FIX engine completes the process of establishing a FIX session between the buy side and sell side counter parties. The process for exchanging FIX messages through an established session will now be described.

3. Delivery of FIX Messages

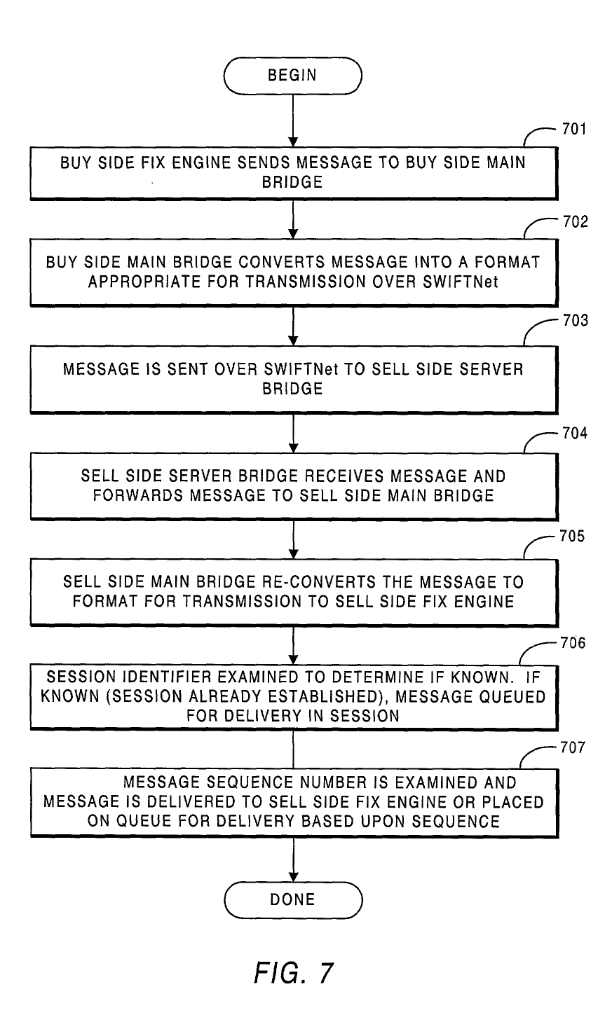

This following discussion describes how two counter parties exchange FIX messages via SWIFTNet using the system and methods of the present invention. FIG. 7 illustrates the detailed method steps of operation of the present invention in the exchanging of FIX messages over SWIFTNet. FIG. 7 and the following discussion use the same example of a “buy side” user exchanging FIX messages with a “sell side” user. For purposes of the following discussion, it is assumed that both the buy side user and sell side have established a FIX session as described above. The process of sending FIX messages over SWIFTNet is illustrated using the example of sending a single FIX message over a single session established between the buy side and the sell side user. However, the present invention is of course not limited for use in this context and the present invention may also be used for sending a number of messages to a number of different counter parties over multiple sessions from time to time. In addition, although the following refers to a message sent from a buy side user to a sell side user, the message can of course also be sent by the sell side user to the buy side user in the same manner.

After a FIX session has been established, the buy side user may wish to send a FIX message to the sell side user (e.g., a message offering to purchase particular securities from the sell side user). At step 701, the buy side user's FIX engine sends a FIX message on the channel (e.g., TCP connection) it has open to the buy side main bridge. When the buy side main bridge receives the FIX message, at step 702 it converts the message to a format appropriate for transmission via SWIFTNet. This conversion process is similar to that previously described above for conversion of the logon message sent to establish a FIX session. The FIX message is typically base64-encoded, bundled in a SWIFTNet envelope, and queued for delivery to SWIFTNet. The SNL address of the sell side server bridge is also attached to the FIX message.

After the FIX message has been converted, at step 703, the converted message is removed from the queue and sent it over SWIFTNet to the sell side server bridge at its SNL address. The sell side server bridge receives the message and, at step 704 the sell side server bridge passes the message to the sell side main bridge via the open channel between the two (e.g., a previously established TCP connection).

When the message is received by the sell side main bridge, at step 705 the sell side main bridge re-converts the message to FIX/TCP format for delivery to the sell side FIX engine. The sell side main bridge typically extracts the message from the SWIFTNet envelope, performs base64-decoding on the message, and attaches session information to the message. At step 706, the sell side main bridge examines the session identifier of the FIX message to determine whether the FIX session is known (e.g., retained in a sell side hash table of FIX session information). As a FIX session has been established between the buy side and the sell side, the FIX session is typically known on the sell side. If the FIX session is known, the message is queued for delivery in this FIX session.

Next, at step 707 the sequence number of the FIX message is examined. If the message is the next message expected, then the message is delivered to the sell side FIX engine and any queued messages that are next in the sequence are also delivered. However, if the message is not the next message expected (meaning it is out of sequence), then the message is queued and the main bridge waits for delivery of the expected message(s) as previously described. If the message is not in sequence, the sell side main bridge waits and sends the message to the sell side FIX engine after all prior messages in the sequence have been received. As previously mentioned, message delivery from the sell side to the buy side works symmetrically.

While the invention is described in some detail with specific reference to a single preferred embodiment and certain alternatives, there is no intent to limit the invention to that particular embodiment or those specific alternatives. For instance, those skilled in the art will appreciate that modifications may be made to the preferred embodiment without departing from the teachings of the present invention.

What is claimed is:

1. A method for transmission of messages conforming to a financial protocol, said financial protocol specifying a particular message sequencing, the method comprising:
receiving at least one of said messages for transmission over a communication channel, said communication channel without support for itself ensuring said particular message sequencing;
assigning an identifier to each said message, said identifier based upon a particular session and a sequence number within said particular session;
transmitting each said message and each said identifier over said communication channel; and
upon receipt of each said message at its destination, placing each said message in sequence to provide said particular message sequencing, said sequence based upon said identifier assigned to each said message.

2. The method of claim 1, wherein said financial protocol includes the Financial Information Exchange (FIX) protocol.

3. The method of claim 1, wherein said communication channel includes the SWIFT network (SWIFTNet).

4. The method of claim 1, further comprising:
establishing a session for transmission of said messages from a first party to a second party over said communication channel.

5. The method of claim 4, wherein said step of assigning an identifier includes assigning said identifier based upon a session identifier of said session.

6. The method of claim 1, further comprising:
establishing a plurality of sessions for transmission of said messages from a first party to at least one second party over said communication channel.

7. The method of claim 1, wherein said step of assigning an identifier includes assigning said identifier based upon a particular session between a first party and a particular second party.

8. The method of claim 1, wherein said step of transmitting each said message includes converting said message into a format appropriate for transmission over said communication channel;

9. The method of claim 8, wherein said step of converting said message into a format appropriate for transmission includes the substeps of:
encoding said message; and
bundling said encoded message in a transmission wrapper;

10. The method of claim 9, wherein said substep of encoding said message includes using base-64 encoding.

11. The method of claim 9, wherein said substep of bundling said encoded message in a transmission wrapper includes using an Extensible Markup Language (XML) transmission wrapper.

12. The method of claim 1, further comprising:
upon receipt of said encoded message at a destination, extracting an encoded message from a transmission wrapper and decoding said encoded message.

13. The method of claim 1, wherein said step of placing each said message in sequence includes the substeps of:
maintaining an ordered delivery queue; and
inserting each said message into said ordered delivery queue based upon said identifier assigned to each said message.

14. The method of claim 1, wherein said step of placing each said message in sequence includes the substeps of:
if a particular message is next in sequence, processing said message; and
if a particular message is out of sequence, placing said message in a queue for processing.

15. The method of claim 1, wherein said step of placing each said message in sequence includes generating a request to resend messages in the event of any gap in sequencing of said messages.

16. The method of claim 1, wherein said step of transmitting each said message includes verifying that each said message was received at its destination.

17. The method of claim 1, further comprising:
selecting a communication channel for transmission of each said message from a plurality of available communication channels.

18. The method of claim 1, further comprising:
establishing a plurality of communication channels for transmission of said messages; and
selecting a communication channel for transmission of said messages from said plurality of communication channels.

19. The method of claim 17, wherein said step of placing each said message in sequence includes reassembling messages sent over a plurality of communication channels.

20. The method of claim 1, further comprising:
establishing a plurality of sessions between a first party and a second party for exchange of said messages; and
transmitting said messages from said plurality of sessions over a single communication channel.

21. A method for sending of communication packages conforming to a particular messaging standard over a plurality of communication channels, said particular messaging standard requiring an ordered processing of said communication packages, the method comprising:
receiving at least one of said communication packages;
assigning a session identifier and a sequence number to each said communication package;
selecting a communication channel for transmission of each said communication package from a plurality of available communication channels;
sending each said communication package together with said session identifier and said sequence number over said selected communication channel;
upon receipt of each said communication package, processing each said communication package in said ordering required by said particular messaging standard based upon said session identifier and said sequence number.

22. The method of claim 21, wherein said financial protocol includes the Financial Information Exchange (FIX) protocol.

23. The method of claim 21, wherein said plurality of available communication channels includes the SWIFT network (SWIFTNet).

24. The method of claim 21, further comprising:
establishing at least one session between a first party and at least one second party for transmission of said communication packages.

25. The method of claim 24, wherein said step of assigning a sequence number includes assigning a sequence number based upon a particular session between said first party and a particular second party.

26. The method of claim 21, wherein said step of sending said communication package over said selected communication channel includes encoding said communication package.

27. The method of claim 26, wherein said step of encoding said communication package includes using base-64 encoding.

28. The method of claim 21, wherein said step of sending said communication package over said selected communication channel includes placing said communication package in a transmission envelope for transmission over said selected communication channel;

29. The method of claim 28, wherein said transmission envelope comprises an Extensible Markup Language (XML) transmission envelope.

30. The method of claim 21, wherein said step of processing each said communication package in said ordering required by said particular messaging standard includes processing a plurality of communication packages sent over a plurality of communications channels.

31. The method of claim 21, wherein said step of processing each said communication package in said ordering required by said particular messaging standard includes the substeps of:
maintaining an ordered queue; and
inserting each said communication package into said ordered queue based upon said session identifier and said sequence number.

32. The method of claim 21, wherein said step of processing each said communication package in said ordering required by said particular messaging standard includes the substeps of:
if a particular communication package is next in order, processing said particular communication package; and
if said particular communication package is out of order, placing said particular communication package in a queue for processing.

33. The method of claim 21, wherein said step of processing each said communication package in said ordering required by said particular messaging standard includes generating a request to resend communication packages in the event of any gap in said ordering of said communication packages.

34. The method of claim 1, further comprising:
establishing a plurality of sessions between a first party and at least one second party for exchange of said communication packages; and
sending communication packages from said plurality of sessions over a selected communication channel.

35. A system for transmitting messages conforming to a session-based financial protocol from a plurality of sessions over a single network connection, the system comprising:
a listener module for accepting said messages conforming to a session-based financial protocol for transmission over a single network connection;
a dispatcher module for establishing a plurality of sessions for exchange of said messages, constructing a session identifier for each session and assigning a sequence number to each outgoing message within each session;
a sender module for transmitting said outgoing messages together with said session identifier and said sequence number over said single network connection; and
a receiver module for receiving incoming messages, placing each said incoming message in its session based upon said session identifier, and processing of each said incoming message in each session in sequence based upon said sequence number.

36. The system of claim 35, wherein said session-based financial protocol includes the Financial Information Exchange (FIX) protocol.

37. The system of claim 35, wherein said single network connection includes a SWIFT network (SWIFTNet) connection.

38. The system of claim 35, wherein said sender module encodes said outgoing messages for transmission.

39. The system of claim 38, wherein said dispatcher module encodes said outgoing messages using base-64 encoding.

40. The system of claim 35, wherein said sender module bundles said outgoing messages in transmission wrappers for transmission.

41. The system of claim 40, wherein said dispatcher module bundles said outgoing messages in Extensible Markup Language (XML) transmission wrappers.

42. The system of claim 35, wherein said receiving module extracts each said incoming message from a wrapper and decodes each said incoming message.

43. The system of claim 35, wherein said sending module implements a communication layering in which the bottom communication layer is SWIFTNet, the middle layer is a TCP/IP layer, and the top layer is FIX over TCP/IP.

44. The system of claim 35, wherein said receiver module processes said incoming messages in sequence by maintaining an ordered queue for each session and inserting each said incoming message into said ordered queue.
